(19) United States
(12) Patent Application Publication
(10) Pub. No.: US 2008/0209685 A1
(43) Pub. Date: Sep. 4, 2008

(54) Furniture Glides

(76) Inventors: Robert N. Dombroski, Waterbury, CT (US); Ralph Carpinella, Woodbury, CT (US); David Ferraro, Cheshire, CT (US)

Correspondence Address: ALIX YALE & RISTAS LLP, 750 MAIN STREET, SUITE 1400, HARTFORD, CT, 06103, US

(21) Appl. No.: 11/918,534

(22) PCT Filed: Apr. 20, 2006
(86) PCT No.: PCT/US06/15327

§ 371 Date: Oct. 12, 2007

(30) Foreign Application Priority Data
Apr. 21, 2005 (US) 11111410

(51) Int. Cl. A47B 91/06; B60B 33/00

(52) U.S. Cl. 16/42 R

(57) ABSTRACT

A furniture glide includes an upper portion for mounting to a furniture leg and a lower portion having a plow base. The plow base includes a lower pad segment having an outer wall that extends downwardly to a bottom sliding surface for sliding on a floor. The outer wall is substantially perpendicular to the sliding surface, forming a sharp outer edge that acts as a plow when the furniture glide is slid along the floor to push dirt or other debris out of the path of the furniture glide. In another embodiment the lower portion of the glide is a two-piece sub-assembly which includes a mounting member having vibration absorbing and/or sound deadening properties.

### CROSS REFERENCE TO RELATED APPLICATIONS

This is a continuation-in-part application which claims priority under 35 U.S.C. § 120 based on utility application Ser. No. 11/111,410, filed Apr. 21, 2005, which claims priority under 35 U.S.C. § 119(e) based on provisional application No. 60/661,100, filed Mar. 11, 2005.

### BACKGROUND

The present invention relates to furniture glides, and more particularly to an improved furniture glide base.

Furniture glides are available in a variety of styles and constructions, but an essential purpose is to provide an upper portion for receiving a furniture leg and a lower portion defining a sliding surface. U.S. Pat. Nos. 5,991,974, “Swivelling Furniture Glide”, and U.S. Pat. No. 6,154,923, “High Hold Furniture Glide”, and U.S. Publication US2002/0088082A1 describe glides of the type having a three main components: (1) a ferrule including a bottom wall, an upstanding cylindrical side wall extending from the bottom wall and defining a socket for receiving a furniture leg, and clip means within the socket, for engaging a received furniture leg, (2) a swivelable glide support shell affixed to the bottom wall of the ferrule, and (3) a glide base affixed to the support shell and defining a substantially flat sliding surface for contacting the floor.

U.S. Pat. No. 6,405,982, “Self-Attaching Sliding Support for Articles of Furniture”, describes another type of glide that does not have a ferrule or swivel capability, but rather consists of a generally cup-shaped, unitary body of a resilient element for gripping the legs and an integrated slidable base element for contact with the floor.

In these and other known furniture glides, the sliding surface for contacting the floor is of a material specifically chosen for its relatively high hardness. Typical base element materials include steel (usually selected for carpeted floors) or hard plastics such as nylon or polyethylene (typically selected for tile floors and older vinyl flooring products containing asbestos). Base elements composed of steel or hard plastic provide durability, easy cleaning of the sliding surface and easy and quiet sliding of the furniture along floors surfaced with carpet or tile, respectively, without abrasion or smudging. However, modern vinyl flooring products do not contain asbestos, and as a consequence are softer than the older vinyl floor products. Furniture glides having conventional base elements tend to scratch and mar the modern vinyl flooring products. Scratching is particularly a problem if there is dirt or debris on the floor which will act as an abrasive between the bottom surface of the furniture glide base element and the floor.

Excessive noise is another problem associated with furniture having glides comprised of conventional base elements. This problem is particularly noticeable in classroom settings where the noise caused by standard furniture glides is annoying as well as disruptive to student concentration and the overall learning environment. Current products designed to lessen this sound range from tennis balls to felt bottom caps placed over the glides. However, these products are not generally very durable nor do they adequately protect the floors from scratching.

### SUMMARY

Briefly stated, the furniture glide includes an upper portion adapted for mounting to a furniture leg and a lower portion having a plow base. The plow base includes a lower pad segment having an outer wall that extends downwardly to a bottom sliding surface for sliding on a floor. The outer wall is substantially perpendicular to the sliding surface, forming a sharp outer edge that acts as a plow when the furniture glide is slid along the floor to push dirt or other debris out of the path of the furniture glide.

The sliding surface of the pad segment may include a recess having an inner wall that is substantially perpendicular to the sliding surface, forming a sharp inner edge. The inner edge acts as a plow when the furniture glide is slid along the floor to push dirt or other debris disposed between the bottom surface and the floor into the recess.

In a first embodiment, the plow base is molded from a polymer material, preferably monopolymer acetal. The polymer material may also include siloxane. For example, the polymer material may comprise 4 to 10% siloxane and 96 to 90% monopolymer acetal. Preferably, the polymer material comprises 4 to 5% siloxane and 96 to 95% monopolymer acetal.

In another embodiment, a vibration absorbing/sound deadening material is integrated into the plow base. The vibration absorbing/sound deadening material is preferably a vinyl polymeric material (PVC), polyurethane (PU) or thermoplastic rubber (TPR). It is further preferred that the vibration absorbing/sound deadening material be molded directly onto the polymer material comprising the plow base.

The upper portion includes a ferrule assembly adapted for receiving and gripping the furniture leg. The lower portion may be pivotally mounted to the upper portion or integrally formed with the upper portion.

Alternatively, the furniture glide may be adapted for receiving and/or gripping a conventional furniture leg by having an upper portion including a circumferential upper lip segment, a circumferential sidewall segment and a lower base segment. The lip segment, the sidewall segment and the base segment define a cavity for receiving a conventional furniture glide mounted on the furniture leg. In one embodiment, the lower base segment also includes a plow base. In another embodiment, a vibration absorbing/sound deadening material is integrated into the lower base segment.

### BRIEF DESCRIPTION OF THE DRAWINGS

The present invention may be better understood and its numerous objects and advantages will become apparent to those skilled in the art by reference to the accompanying drawings in which:

FIG. 1 is a side view, partly in cross-section, of a first variety of furniture glide having a plow base in accordance with a first embodiment;

FIG. 2 is an enlarged perspective view of the plow base of FIG. 1;

FIG. 3 is a bottom view of the plow base of FIG. 1;

FIG. 4 is an enlarged view of area IV of FIG. 1;

FIG. 5 is a side view, partly in cross-section, of a furniture glide having a plow base in accordance with a second embodiment;

FIG. 6 is a perspective view of the plow base of FIG. 5;

FIG. 7 is cross-sectional view of the plow base of FIG. 5;

FIG. 8 is an enlarged view of area VIII of FIG. 5;

FIG. 9 is a bottom view of a plow base having a first variation of the pad segment;

FIG. 10 is a bottom view of a plow base having a second variation of the pad segment

FIG. 11 is a top perspective view of a second variety of furniture glide having a plow base in accordance with a third embodiment;

FIG. 12 is a bottom perspective view of the furniture glide of FIG. 11;

FIG. 13 is a side view, partly in cross-section, of the furniture glide of FIG. 11;

FIG. 14 is an enlarged view of area XIV of FIG. 13;

FIG. 15 is a top perspective view of a third variety of furniture glide having a plow base in accordance with a fourth embodiment;

FIG. 16 is a bottom perspective view of the furniture glide of FIG. 15;

FIG. 17 is a side view, partly in cross-section, of the furniture glide of FIG. 15;

FIG. 18 is an enlarged view of area XIV of FIG. 17;

FIG. 19A is a bottom view of another embodiment of the plow base of FIG. 2;

FIG. 19B is a cross sectional view along the line 19-19 of FIG. 19A;

FIG. 20A is a bottom view of another embodiment of FIGS. 19A-B;

FIG. 20B is a cross sectional view along the line 20-20 of FIG. 20A;

FIG. 21A is a bottom view of another embodiment of the plow base of FIG. 6;

FIG. 21B is a cross sectional view along the line 21-21 of FIG. 21A;

FIG. 22A is a bottom view of another embodiment of FIGS. 21A-21B; and

FIG. 22B is a cross sectional view along the line 22-22 of FIG. 22A.

### DETAILED DESCRIPTION

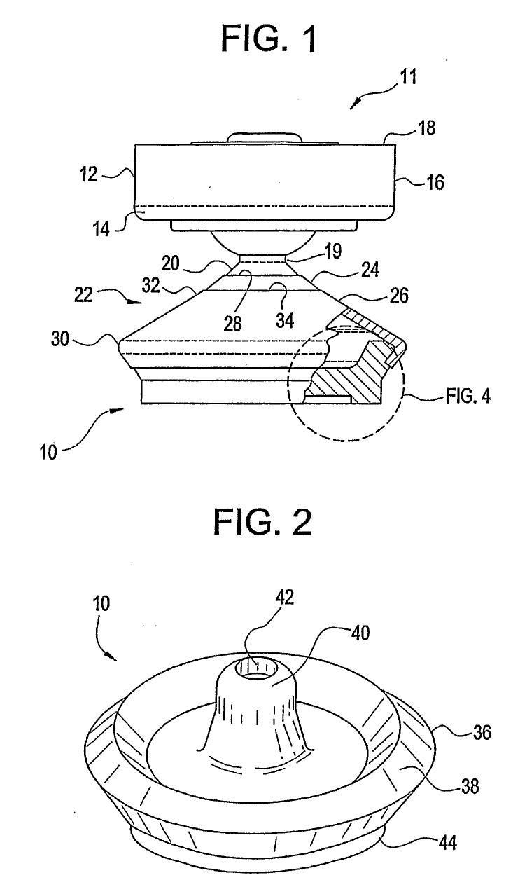

FIGS. 1-4 illustrate a first embodiment of a plow base 10, in the context of swivel furniture glides 11 such as described in U.S. Pat. No. 5,991,974, “Swivelling Furniture Glide” and U.S. Pat. No. 6,154,923, “High Hold Furniture Glide”, and U.S. Publication US2002/0088082A1, the disclosures of which are hereby incorporated by reference.

A ferrule for receiving a furniture leg, is generally designated by the numeral 12. The ferrule 12 has a circular bottom wall 14 and an upstanding cylindrical side wall 16 forming a circular ferrule opening 18. The ferrule opening 18 is preferably chosen to closely match the outer diameter of the furniture leg (not shown). The bottom wall 14 defines a circular rivet opening (not shown) coaxial with the ferrule opening 18.

A clip (not shown) disposed within the ferrule 12 may take a variety of forms. For example, the clip may be formed from a longitudinal resilient metal strip. The clip has a clip base which has a footprint smaller than the ferrule opening 18, and a single pair of oppositely positioned clip arms. The clip arms extend generally perpendicularly upward from the clip base. The unstressed clip arms define a neutral diameter greater than the diameter of the ferrule opening 18. The arms and base of the clip are resiliently deformable whereby as the clip is inserted base first into the ferrule opening 18, the clip arms deform inwardly to the smaller diameter of the ferrule opening 18. The clip arms return to generally the neutral shape after passage through the ferrule opening 18. The clip base defines a central clip rivet opening. The clip rivet opening is aligned with the ferrule rivet opening when the clip is mounted in the ferrule 12. The rivet openings are of the same diameter.

A rivet 19 is secured through the clip and ferrule rivet openings. The rivet 19 has an expandable head portion (not shown) and an opposite swivel portion 20. The head portion of the rivet 19 is inserted through the aligned rivet openings and rounded or peened over to pull the swivel portion 20 against the bottom wall 14 of the ferrule 12. The rivet 19 securely fastens the ferrule 12 and clip together. The clip and ferrule 12, when riveted together, are capable of fully supporting a furniture leg, and therefore preferably do not require any additional structural elements. The swivel portion 20 of the rivet 19 extends downward from the bottom wall 14 and radially outward to define a convex spherical outer swivel surface and a concentric inner spherical swivel surface.

A shell assembly 22, having an inner shell 24 and an outer shell 26, slidably engages the outer swivel surface of the rivet 19. The inner shell 24 is generally spherical and defines a circular inner shell opening 28 having a diameter less than the swivel portion 2 of the rivet 19. The inner shell 24 is nested within the outer shell 26. The outer shell 26 has a generally frustoconical shape forming an expanded portion 30 defining an outer edge and a reduced portion 32. The outer shell 26 defines a circular outer shell opening 34 at the reduced portion 32 having a diameter less than the outer diameter of the inner shell 24. The spherical shape of the inner shell 24 allows for improved swiveling sliding engagement of the inner shell 24 with the outer shell 26.

The plow base 10 is mounted to the expanded portion 30 of the outer shell 26. The plow base 10 is preferably molded as a unitary or singular component of polymer material that is more slippery than material conventionally used for this purpose. Preferably the material is monopolymer acetal having an additive, for example siloxane, to provide slippery properties to the plow base 10. Preferably, the plow base 10 is composed of 4 to 5% siloxane additive and 96 to 95% acetal. Up to 10% of the siloxane additive may be used, making the plow base 10 more slippery but reducing wear resistance. The plow base 10 includes a circular, upper, mounting segment 36, having an annular rim portion 38 for engagement to the outer shell 26. The plow base 10 is mounted in position by the crimped outer edge of the outer shell 26, which encloses the annular rim portion 38 of the mounting segment 36. An axial central post segment 40 extends upwardly from the mounting segment 36 to a contact surface 42. In one embodiment the contact surface 42 is configured as a generally convex base swivel surface that engages in congruent surface-to-surface contact with the inner swivel surface of the rivet 19. In another embodiment, the contact surface 42 is configured as a generally concave socket-type surface. The post segment is 40 dimensioned of a sufficient height to maintain the shell assembly 22 in tight engagement with the swivel portion 20 of the rivet 19. The swivel portion 20, inner shell 24, outer shell 26 and plow base 10 are dimensioned to allow swiveling motion of the ferrule 12 relative to the plow base 10.

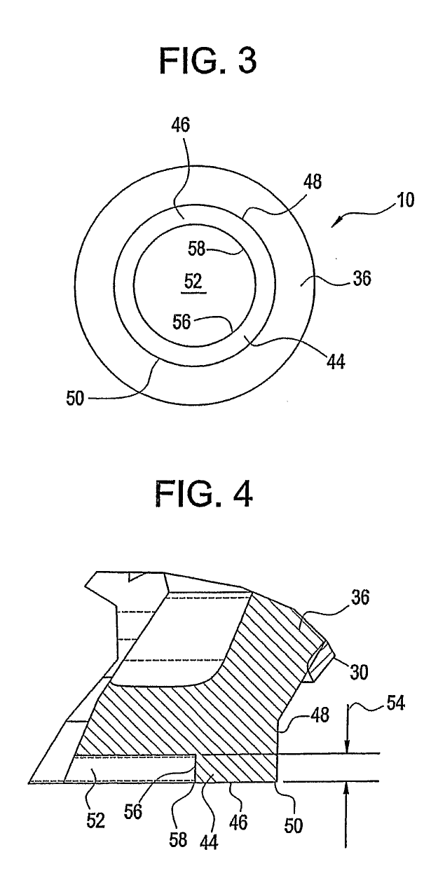

A lower pad segment 44 extends downwardly from the mounting segment 36 of the plow base 10 to a sliding surface 46. The outer wall 48 of the pad segment 44 is substantially perpendicular to the sliding surface 46, forming a sharp outer edge 50. The sharp outer edge 50 of the plow base pad segment 44 acts as a plow when the furniture glide 11 is slid along the floor, for example when a chair having leg mounted furniture glides 11 is slid back from a table. More specifically, dirt or other debris is pushed out of the path of the furniture glide 11 as the furniture to which they are mounted are slid along the floor. The sharp outer edge 50 prevents such dirt or debris from sliding under the plow base 10. The pad segment 44, 44′ may have a circular-shape (FIG. 3), a square shape (FIG. 10), or any other shape, so long as the outer wall 48, 48′ of the pad segment 44, 44′ is substantially perpendicular to the sliding surface 46, 46′.

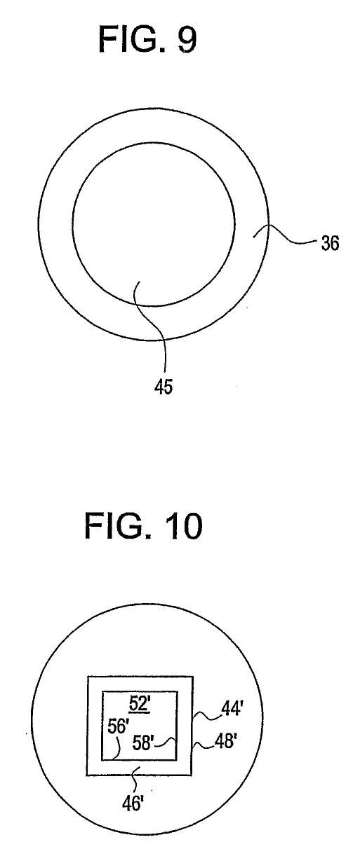

The pad 44, 44′ segment may have an axial recess 52, 52′, preferably having a height 54 of 0.04 inches. The inner wall 56, 56′ of the pad segment 44, 44′ is substantially perpendicular to the sliding surface 46, 46′, forming a sharp inner edge 58, 58′. The sharp inner edge 58, 58′ of the plow base pad segment 44, 44′ acts as a plow after the piece of furniture is initially placed on the floor or after the piece of furniture is moved by lifting it and setting it back down. Any dirt/debris that is disposed between the floor and the plow base 10 will be plowed into recess 52, 52′ by the sharp inner edge 58, 58′, if the furniture is then slid along the floor. The recess 52, 52′ may have a circular-shape (FIG. 3), a square shape (FIG. 10), or any other shape, so long as the inner wall 56, 56′ of the pad segment 44, 44′ is substantially perpendicular to the sliding surface 46, 46′. Alternatively, the pad segment 45 may be solid and have no recess, as shown in FIG. 9.

Since dirt/debris cannot become trapped between the sliding surface and the floor, the scratching and marring of conventional furniture glides is prevented. It should be understood that the sharp edges of the plow base are best suited for use on harder floor surfaces, such as tile.

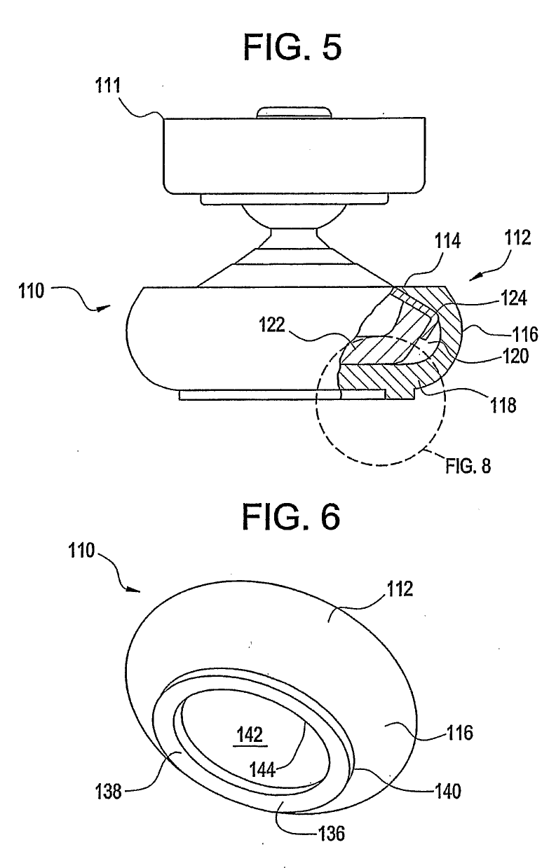

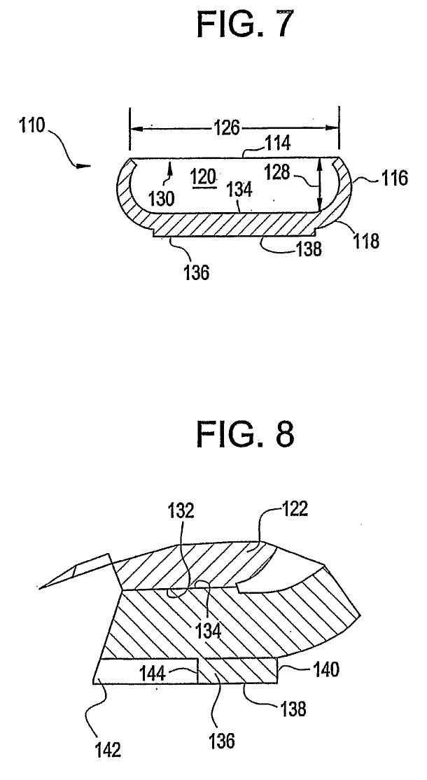

FIGS. 5-8 illustrate a second embodiment of a plow base 110, that is intended for use with installed, conventional furniture glides 111. The plow base 110 is preferably molded as a unitary or singular component of polymer material that is softer and more slippery than material conventionally used for this purpose. Preferably the material is the acetal/siloxane additive material described above. The plow base 110 includes a circular, upper, mounting segment 112, having a circumferential upper lip segment 114, a circumferential sidewall segment 116 having a C-shaped cross-sectional profile, and a lower base segment 118 forming a cavity 120 for receiving the glide base 122 and the expanded portion 124 of a conventional furniture glide 111. The inner diameter 126 of the sidewall segment 116 and the distance 128 between the lip segment 114 and the base segment 118 may be selected to provide a cavity 120 that can receive any given conventional furniture glide 111. As shown in FIGS. 5 and 8, the material from which the plow base 110 is manufactured is flexible enough that the lip segment 114 may be stretched to widen the opening 130 for receiving the furniture glide 111. After the furniture glide 111 is inserted into the cavity 120, the sliding surface 1321 of the furniture glide 111 rests on the upper surface 134 of base segment 118.

A lower pad segment 136 extends downwardly from the mounting segment 112 of the plow base 110 to a sliding surface 138. As discussed above, the pad segment 136 may have substantially any shape, so long as the outer wall 140 of the pad segment 136 is substantially perpendicular to the sliding surface 138. The pad segment 136 may have an axial recess 142. As discussed above, the axial recess 142 may have substantially any shape, so long as the inner wall 144 of the pad segment 136 is substantially perpendicular to the sliding surface 138.

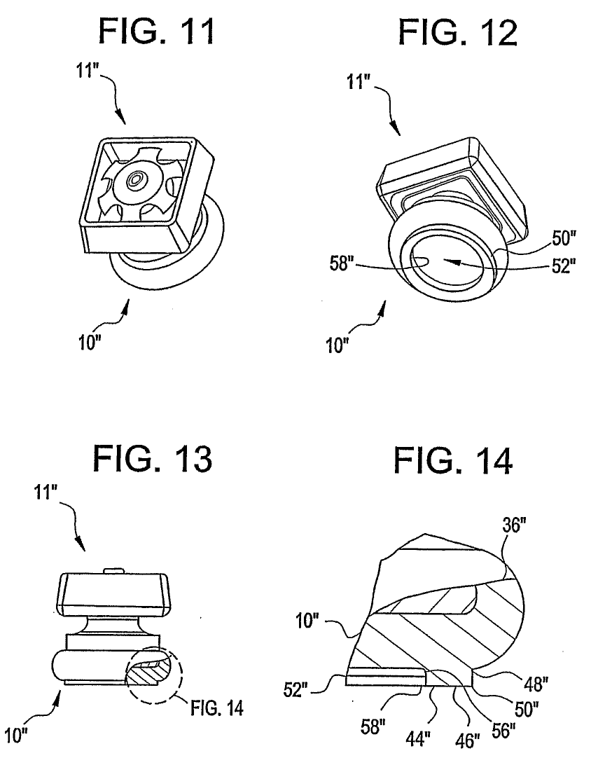

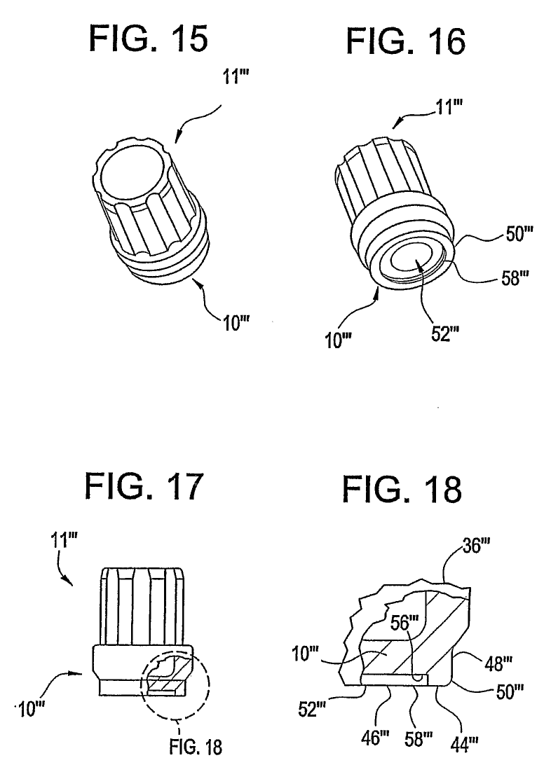

FIGS. 11-14 illustrate a second variety of furniture glide 11″ for use with a tubular furniture leg having a substantially square-shaped cross-sectional profile. In this variety, the plow base 10″ is pivotally attached to the ferrule assembly in a manner similar to that of the first variety of furniture glide 11. FIGS. 15-18 illustrate a third variety of furniture glide 11′″ for use with a furniture leg that may be tubular or solid, and preferably has a substantially circular cross-sectional profile. In this variety of furniture glide 11′″, the plow base 10′″ is integrally formed with the ferrule assembly. The plow base 10″ of furniture glide 11″ and the plow base 10′″ of furniture glide 11′″ are substantially similar to the plow base 10 of furniture glide 11. All of the plow bases 10″, 10′″ include a lower pad segment 44″, 44′″ that extends downwardly from a mounting segment 36″, 36′″ to a sliding surface 46″, 46′″. The outer wall 48″, 48′″ of the pad segment 44″, 44′″ is substantially perpendicular to the sliding surface 46″, 46′″, forming a sharp outer edge 50″, 50′″. The pad 44″, 44′″ segment may include an axial recess 52″, 52′″, having an inner wall 56″, 56′″ that is substantially perpendicular to the sliding surface 46″, 46′″, forming a sharp inner edge 58″, 58′″.

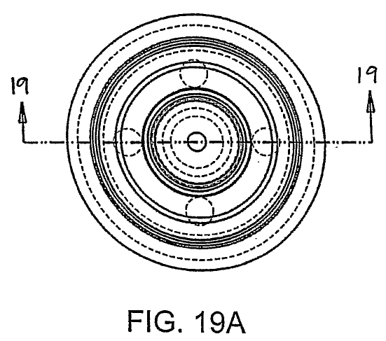

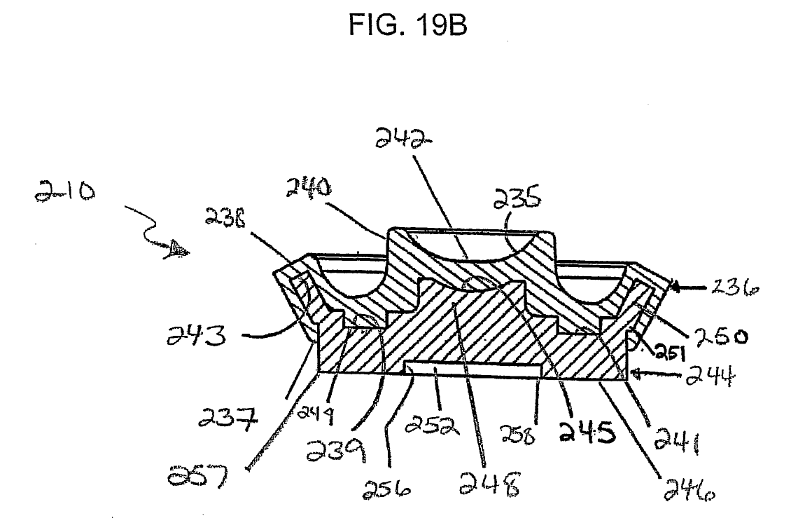

FIGS. 19A and 19B illustrate another embodiment of a plow base 210. According to this embodiment, the plow base 210 is a substantially circular two-piece sub-assembly molded from polymeric materials having a mounting member 236 and a pad member 244. The top surface 235 of the mounting member 236 has an axial central post portion 240 that extends upwardly to form a contact surface 242. Contact surface 242 is configured to engage in congruent surface-to-surface contact with the inner swivel surface of the rivet 19 as described above. Preferably, contact surface 242 is configured as being a generally concave swivel or socket surface. It should be understood that the contact surface 242 could alternatively be configured as a convex base swivel surface as shown in FIG. 2. Mounting member 236 extends downwardly from an outer annular rim portion 238 to a lower edge 237. The annular rim portion 238 is enclosed by the crimped outer edge of the outer shell 26 of the shell assembly 22 as shown in FIG. 1. It is preferred that the interior surface 239 of the mounting member 236 have at least a central generally arcuate protrusion 245, a plurality of circular projections 241, and an annular trough 243. Preferably, the pad member 244 is directly molded onto the interior surface 239 of mounting member 236 during the manufacturing process. Thus, at least the upper portion 248 of the pad member 244 mateably interfits with the interior surface 239 of mounting member 236.

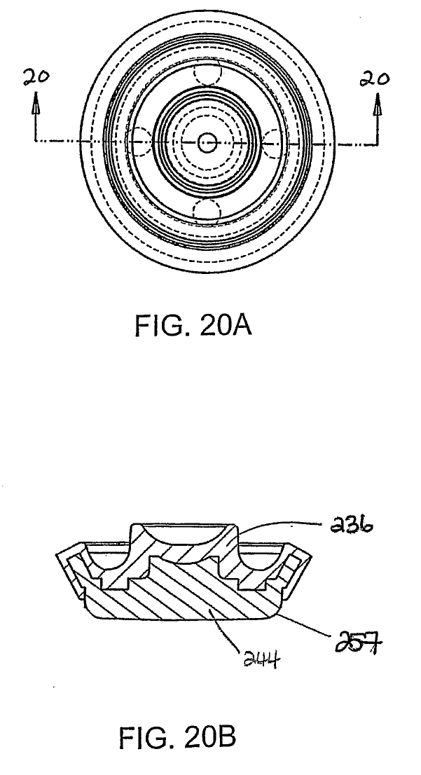

The upper portion 248 of pad member 244 preferably has at least a central arcuate or hemispherical depression 247, a plurality of circular recesses 249 to receive the projection(s) 241 and a raised lip 250 to engage the annular trough 243. Raised lip 250 may also have a shoulder 251 to engage the lower edge 237 of the mounting member 236. It is preferred that the lower portion 253 of pad member 244 extend downwardly beyond the lower edge 237 of mounting member 236, whereby the bottom forms a flat sliding surface 246. Preferably, the pad member 244 has a coaxial cylindrical recess 252. The inner walls 256 are substantially perpendicular to the sliding surface 246, forming a sharp inner edge 258. The sharp inner edge 258 acts as a plow pushing any debris into the recess 252 as the plow base 210 is advanced along the floor. The pad member 244 may have a sharp outer edge 257 that also acts as a plow by pushing debris out of the path of the furniture glide as discussed above. The recess 252 can have any shape so long as the inner walls 256 of the recess 252 are perpendicular to the sliding surface 246. Alternatively, the pad member 244 may have a rounded outer edge 257 and no recess, as shown in FIGS. 20A and 20B. It should be understood that glides having a pad member with a rounded outer edge and no recess are best suited for use on carpets.

According to a preferred embodiment, the mounting member 236 and the pad member 244 are manufactured from different polymer materials having different Shore hardness values. The mounting member 236 may be molded from a relatively softer polymer material than the pad member 244. Preferably, the pad member 244 is molded from monopolymer acetal having a siloxane additive, as described above, and has a Shore D hardness value of at least 70. The mounting member 236 has a preferred Shore D hardness value in the range of about 30 to 60. It is preferred that the mounting member 236 has vibration absorbing and/or sound deadening properties. It is further preferred that the mounting member 236 is polyvinyl chloride (PVC), polyurethane (PU) or thermoplastic rubber (TPR) that is directly molded to the pad member 244 during manufacture.

Because the mounting member 236 is made of a softer, vibration absorbing and/or sound deadening polymer material, there is substantially less noise as the furniture is moved across the floor while also protecting the floor from scratching. It should be understood that the mounting member 236 with vibration absorbing and/or sound deadening properties can be used in conjunction with pad members with or without a recess.

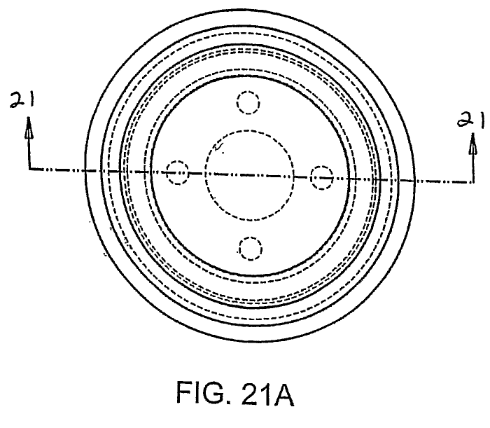

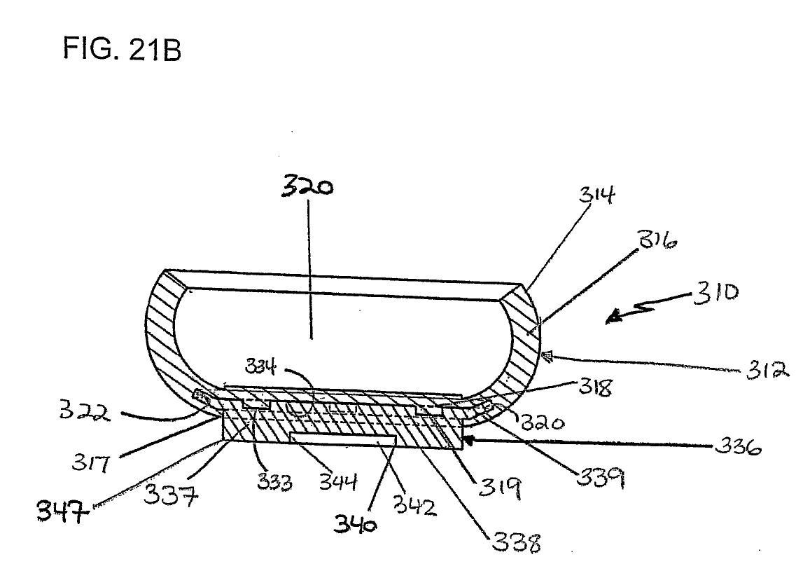

FIGS. 21A and 21B illustrates a further embodiment of a plow base 310, for use in conjunction with installed, conventional furniture glides, 111. In this embodiment, the plow base 310 is a two-piece molded sub-assembly having a circular mounting member 312 and a pad member 336. The mounting member has a circumferential lip portion 314, a C-shaped sidewall portion 316 extending to a lower rim 317 and forming a base portion 318. The sidewall portion 316 and the base portion 318 define a cavity 320 that is configured to receive any given conventional furniture glide 111. In one preferred embodiment, a plurality of circular projections 319 extends outwardly from the base portion 318. Mounting member 312 may also have a circumferential trough 322 located between the base portion 318 and the inside surface 320 of the lower rim 317, extending upwardly within the sidewall portion 316.

The material from which mounting member 312 is manufactured is flexible enough so that the lip portion 314 may be stretched wide enough to accommodate the furniture guide 111 and is relatively softer than the polymer material used to manufacture the pad member 336. In one preferred embodiment, the mounting member 312 has a Shore D hardness of about 30 to 60, while the pad member 336 has a Shore D hardness of at least 70. It is also preferred that the mounting member 312 has vibration absorbing and/or sound deadening properties. Preferably, the mounting member 312 is made of polyvinyl chloride (PVC), polyurethane (PU) or thermoplastic rubber (TPR) that has been molded directly onto pad member 336. Pad member 336 is preferably manufactured from the acetal/siloxane additive material described above.

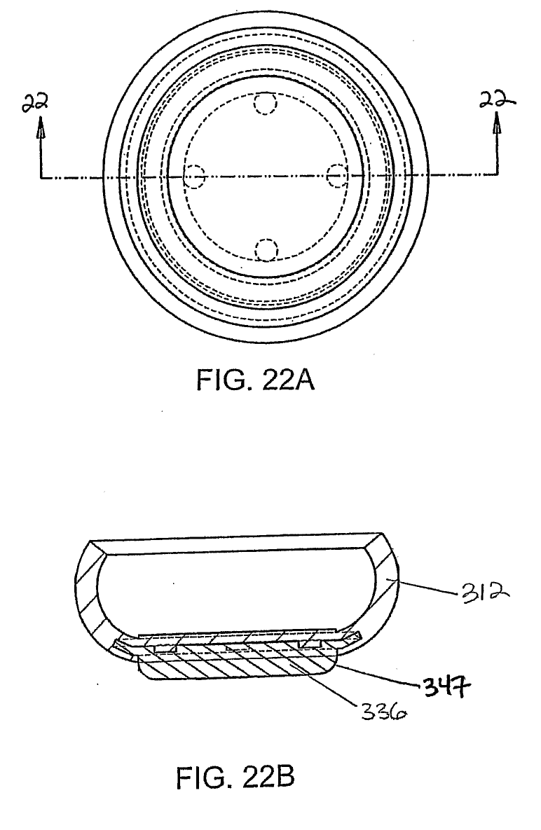

As shown in FIG. 21B, pad member 336 has an upper surface 334 that mateably interfits at least with the base portion 318 and the trough 322 of mounting member 312. The upper surface 334 may also have a plurality of circular recesses 333 configured to receive the projection(s) 319 and a radially extending lip 339 to engage the trough 322. The pad member 336 has a lower portion 337 that extends downwardly from the base portion 318 to form a sliding surface 338. The pad member 336 may have a coaxial cylindrical recess 342 with a sharp inner edge 340. As discussed above, the recess 342 may have substantially any shape, so long as the inner wall 344 of the pad member 336 is substantially perpendicular to the sliding surface 338. The pad member 336 may also have a sharp outer edge 347 that acts as a plow to push debris out of the path of the furniture glide. Alternatively, the pad member 336 may have a rounded outer edge 347 and no recess, as shown in FIGS. 22A and 22B.

While preferred embodiments have been shown and described, various modifications and substitutions may be made thereto without departing from the spirit and scope of the invention. Accordingly, it is to be understood that the present invention has been described by way of illustration and not limitation.

1-23. (canceled)

24. A furniture glide comprising:
an upper portion adapted for mounting to a furniture leg; and
a lower portion comprised of a two-piece subassembly including a lower pad segment having an outer wall extending downwardly to a bottom sliding surface adapted for sliding on a floor and defining a substantially blunt outer edge.

25. The furniture glide of claim 24 wherein the lower portion is molded from two polymeric materials having different Shore D hardness values.

26. The furniture glide of claim 24 wherein said lower portion comprises a mounting member molded from a first polymeric material having a Shore D hardness of about 30 to 60; and
said lower pad segment having said outer wall molded from a second polymeric material having a shore D hardness of at least 70.

27. A furniture glide comprising:
an upper part adapted for fastening to a furniture leg; and a lower part comprising a two-piece plow base sub-assembly including a mounting member and a pad member having a lower portion extending downwardly to a sliding surface having a sharp outer edge and adapted for sliding on a floor;
wherein the mounting member has vibration absorbing and sound deadening properties.

28. The furniture glide of claim 27 wherein the sliding surface defines a recess having a sharp inner edge that acts as a plow when the furniture glide is slid along the floor.

29. The furniture glide of claim 27 wherein the mounting member and the pad member are molded from polymeric materials having different Shore D hardness values.

30. The furniture glide of claim 29 wherein the mounting member has a Shore D hardness of about 30 to 60.

31. The furniture glide of claim 29 wherein the pad member has a Shore D hardness of at least 70.

32. The furniture glide of claim 29 wherein the mounting member is molded from a polymer material selected from the group consisting of polyvinyl chloride (PVC), polyurethane (PU), and thermoplastic rubber (TPR); and the pad member comprises monopolymer acetal with between 4 to 10% siloxane.

33. The furniture glide of claim 29 wherein the pad member is molded directly onto the mounting member during the manufacturing process.

34. The furniture glide of claim 27 wherein
the mounting member has a first side and an opposing second side;
the pad member has an upper portion opposite to said sliding surface; and
the second side of the mounting member and the upper portion of the pad member mateably interfit.

35. The furniture glide of claim 34 wherein
said first side of said mounting member comprises a central post portion defining a contact surface, and an outer annular rim portion that extends downwardly to a lower edge;
said second side of said mounting member comprises a plurality of projections and an annular trough; and
the contact surface and the annular rim portion are adapted for mounting to the upper part of said furniture glide.

36. The furniture glide of claim 35 wherein
said upper portion of said pad member comprises a plurality of recesses to receive said plurality of projections;
a raised circumferential lip to engage said annular trough; and
a shoulder to engage said lower edge.

37. The furniture glide of claim 27 wherein the mounting member of said two-piece plow base sub-assembly comprises:
a circumferential lip portion;
a C-shaped sidewall portion extending to a lower rim;
a base portion; and
a lower rim;
wherein the lip portion, the sidewall portion and the base portion define a cavity for receiving a conventional floor glide attached to a furniture leg.

38. The furniture glide of claim 36 wherein the mounting member further comprises:
a plurality of projections extending from said base portion; and
a circumferential trough between said base portion and said lower rim.

39. The furniture glide of claim 37 wherein the pad member of said two piece plow base sub-assembly has an upper surface that mateably interfits with at least said base portion and said trough of said mounting member.

40. The furniture glide of claim 38 wherein the upper surface of said pad member comprises a plurality of recesses and a radially extending lip.

41. The furniture glide of claim 39 wherein said sliding surface of said pad member defines a recess having a sharp inner edge that acts as a plow when the furniture is slid along the floor.

42. The furniture glide of claim 36 wherein the pad member is comprised of monopolymer acetal with between 4 to 10% siloxane.

43. The furniture glide of claim 36 wherein the mounting member is comprised of a polymer material selected from the group consisting of polyvinyl chloride (PVC), polyurethane (PU), and thermoplastic rubber (TPR).

44. The furniture guide of claim 36 wherein
the pad member has a Shore D hardness value of at least 70; and
the mounting member has a Shore D hardness value of about 30 to 60.

45. The furniture glide of claim 36 wherein the pad member is molded directly onto the mounting member during the manufacturing process.
